(19) United States
(12) Patent Application Publication
(10) Pub. No.: US 2003/0108416 A1
(43) Pub. Date: Jun. 12, 2003

(54) Device for the stacking of flat objects in containers that are open on one side

(76) Inventors: Holger Schererz, Rehfelde (DE); Frank Voss, Berlin (DE); Bertram Wanner, Meersburg (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/345,481

(22) Filed: Jan. 17, 2003

Related U.S. Application Data
(63) Continuation of application No. PCT/DE01/02696, filed on Jul. 18, 2001.

(30) Foreign Application Priority Data
Jul. 27, 2000 (DE) 100 36 681.3

(51) Int. Cl. B65G 57/11

(52) U.S. Cl. 414/794.4; 414/791.1; 414/926; 271/2

(57) ABSTRACT

The present invention comprises a system and method for loading or stacking objects into open top containers. The objects may be flat with wide and narrow sides and may further comprise mail pieces. The system comprises a pivoting unit for pivoting a container holding member into one of at least two positions: a top position, and a stacking position. In the top position, the container is held such that the open top faces substantially upwards, while in the bottom position the top faces substantially horizontal. A stacking aid is introduced into the container when it is held in the top position. The stacking aid includes an inclined wall that helps guide the objects into the container. A height sensor may also be included. The pivoting unit may also include a horizontal extension unit which may telescope the container in a horizontal direction. This facilitates easier manual handling of the container. An object transport unit is also included which transports the flat objects to the containers, the objects to be loaded in a substantially horizontal direction into the substantially horizontally accommodated container.

### CROSS REFERENCE TO RELATED APPLICATIONS

The present application is a continuation of international application number: PCT/DE01/02696, filed Jul. 18, 2001; and claims priority to German patent application DE 10036681.3, filed Jul. 27, 2000; both of which are incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The invention relates to the field of postal automation and mail handling and more particularly to a device, system and method for stacking objects such as flat mail pieces into open top containers.

For purposes of illustration without limitation to the scope of the invention, the present invention will be described with respect to the handling of mail items. It is common during different postal automation processes to transport processed (sorted, ordered, distributed) mail items in open containers, i.e. the mail pieces are put into the containers after termination a process. The mail items are placed horizontally into the containers. The containers, having an open top, are particularly well suited for over-sized letters. A mail piece stack is therefore created by the overlapping or stacking of the mail pieces. The receiving capacity of a container intended for this task is limited by height. Because of the different and uncontrolled falling distances of mail pieces from the top into the containers, the resulting mail piece stack within the container does not make efficient use of the container space. To avoid an overturn of short mail pieces or objects during the relatively long flight, slides were extended with special, inclinable parts (DE 98 50 174 C1) from which the objects glide into the containers. If a wide spectrum of merchandise regarding the format of the mail pieces should be processed, the following problem arises during horizontal stacking: different sized mail pieces aligned at one lateral edge create a wedge shape at super positioning or stacking which can lead to an overturn of the stack at a certain degree. This problem also occurs with magazines of approximately the same size because the bounded edge is usually thicker than the open edge. In a sequencing sorting system, wherein the sorting order has to be absolutely met, the overturn of the stack is associated with a possible loss of the sequence integrity.

### BRIEF SUMMARY OF THE INVENTION

The present invention is directed to a device, system and method for the secure stacking of horizontally transported, flat objects, of a wide spectrum of format and thickness, in containers that are open on one side, wherein the stacking quality and the maximal stacking height obtainable with these containers is increased.

An underlying concept of the present invention is to first keep the route of the horizontally furnished objects as free as possible from twistings as well as small and constant as possible. Second, to transport the objects standing on their edges within the container so that the height of the container no longer determines or effects the object stacking height. This is facilitated by a container, tipped for loading in such a way that the opening is located on the side or otherwise faces substantially horizontally. The objects are delivered laterally into the containers and the container bottom assumes the function of an impact wall. After the filing of the container, it is turned substantially upright and back to an initial position so that the objects now stand on their narrow side within the container. The container top now faces substantially upward. Because the containers are not always dimensionally uniform, the side walls are often placed diagonal to the outside and for the stacking conditions to stay the same during the stacking process, a stacking aid is inserted into the container and later removed after stacking. The stacking aid has a side wall to which the inserted items or objects may be aligned. In effect, the side walls level inclines of the container walls. Furthermore, included is a stacking bottom and moving towards the stacking direction, which is inclined in the inserting direction and towards the side wall. To guarantee a defined insertion flight behavior of the objects or mail pieces during the filing, the stacking aid possesses a guiding device, above the insertion level, for the safe guiding of the different objects as well as for facilitating select flight behavior into the horizontal stacked position.

It is therefore an advantage of the present invention to incline the container into an interchangeable position so that the stack of the flat objects standing on their narrow sides is aligned to the lateral wall of the stacking aid and to the bottom of the container. A stack which is clear in appearance results and overturned objects are avoided. In another embodiment, the stacking aid may include a bin level sensor which recognizes the height of the top of the stack of horizontal objects.

It is another advantage of the present invention, to locate the bottom of the stacking at a select height within the container. Accordingly, relatively similar stacking conditions ensue and the insertion flight route of the object is made as short as possible.

These and other advantages of the present invention are realized by a stacking device for stacking an object in a stack within a container, said container having walls defining an open top, hollow cavity, and bottom, comprising: a pivoting unit for pivoting said container between a top position, wherein said top faces substantially upward, and a stacking position, wherein said top faces substantially horizontally such that objects may be staked in said cavity; and a stacking aid for aiding object stacking and functionally associated with said pivoting unit, said stacking aid comprising a lateral wall, a stacking bottom inclined to said lateral wall, a guidance device for guiding said object into a horizontal sequential stack, and engaging means for lowering and raising said stacking aid into and from said at least one container.

These and further other advantages of the present invention are further realized by a system for stacking a plurality of objects into a plurality of containers comprising: at least one stacking device for stacking said objects in a stack within said containers, said containers having walls defining an open top, hollow cavity, and bottom, said stacking device including a pivoting unit for pivoting said containers between a top position, wherein said top faces substantially upward, and a stacking position, wherein said top faces substantially horizontally such that objects may be staked in said cavity; and a stacking aid for aiding object stacking and functionally associated with said pivoting unit, said stacking aid comprising a lateral wall, a stacking bottom inclined to said lateral wall, a guidance device for guiding said object into a horizontal sequential stack, and engaging means for lowering and raising said stacking aid into and from said at least one container; and transporting means for transporting and supplying said objects to said at least one stacking device, said transporting means comprising successively arranged, downwardly directed, pivoting endless loop transporting modules, whereby a module is positioned in front of said at least one stacking device and can be made to pivot downward into a loading position for loading said objects into said at least one container in a substantially horizontal direction.

These and still other advantages of the present invention are realized by a method for stacking an object in a container, comprising the steps of: pivoting said container between a top position with a pivoting unit of a stacking device, wherein said top faces substantially upward, and a stacking position, wherein said top faces substantially horizontally such that objects may be staked in said cavity; aiding the stacking of said object with a stacking aid functionally associated with said pivoting unit, said stacking aid comprising a lateral wall, a stacking bottom inclined to said lateral wall, a guidance device for guiding said object into a horizontal sequential stack, and engaging means for lowering and raising said stacking aid into and from said at least one container; and transporting and supplying said objects to said at least one stacking device with transporting means, said transporting means comprising successively arranged, downwardly directed, pivoting endless loop transporting modules, whereby a module is positioned in front of said at least one stacking device and can be made to pivot downward into a loading position for loading said objects into said at least one container in a substantially horizontal direction.

At a determined thickness of the stack, the supply of the objects can be interrupted, so that an overflow is avoided. To guarantee good access to the containers in the interchangeable position for a manual container change, it is advantageous, according to another embodiment, to provide the pivoting unit with a horizontal extension unit on which the container receiver and the stacking aid are located. Telescopicing tracks are provided for the horizontal mechanism of the container receiver and the stacking aid in an advantageous realization. The stacking aid moving upwards and back from the container located in the container receiver is advantageous if the horizontal extension unit has moved out from the area of the insertion location. This is necessary to avoid a collision with the structural components carrying the objects during the run-up of the stacking aid. Furthermore, a manual container change is thereby made possible for the operator in an ergonomic position.

In still another embodiment, an automatic transport for the containers may be provided, the transport located below the container receiver, such that, via a lifting mechanism, new containers are automatically provided and used containers automatically disengaged from the container receiver. Accordingly, the stacking of objects within the containers can be automated. In addition, this embodiment foregoes the need for a horizontal transport unit for telescoping the containers, as now, the advantage of ergonomic manual exchange of containers is no longer necessary.

For the safe guiding of the objects into the containers, it is advantageous, to place rotating, flexible pressure rollers above the transporting modules for the pressing of the flat objects against the transporting modules.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a perspective view of three successively arranged stacking devices,

FIG. 2 depicts a perspective view of a single stacking device,

FIG. 3 depicts a perspective view of a stacking device which is horizontally extended for the container change, and

FIG. 4 depicts a perspective view of a horizontally extended stacking device with a stacking device extending from the container directing upwards.

### DETAILED DESCRIPTION OF THE INVENTION

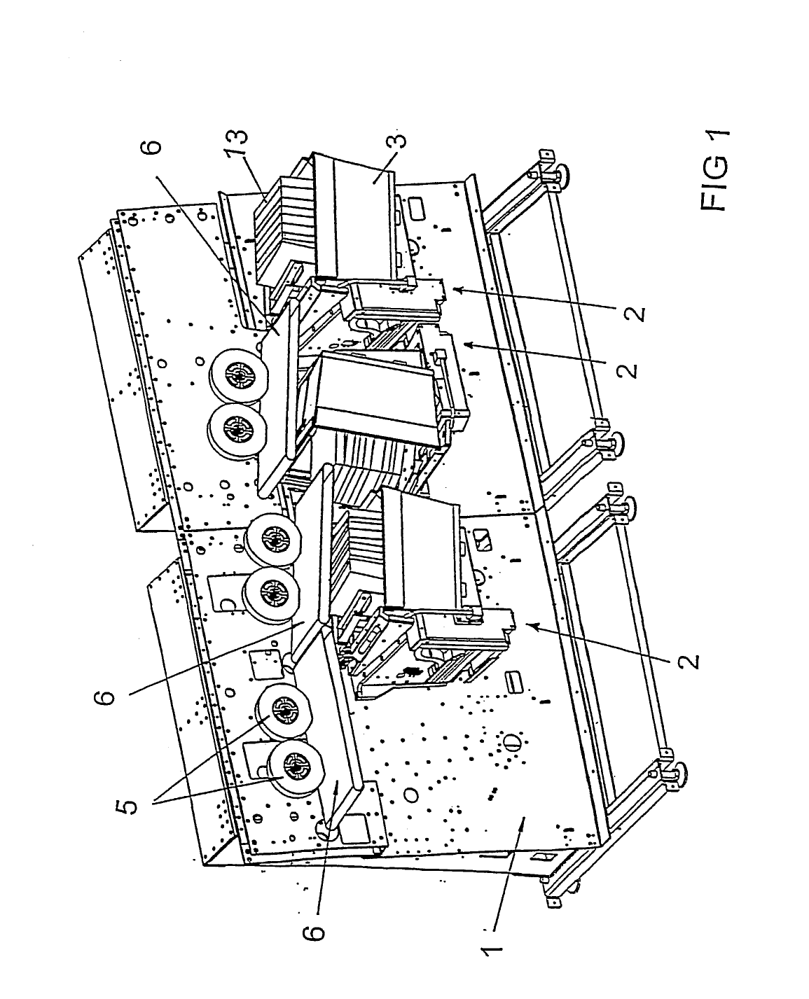

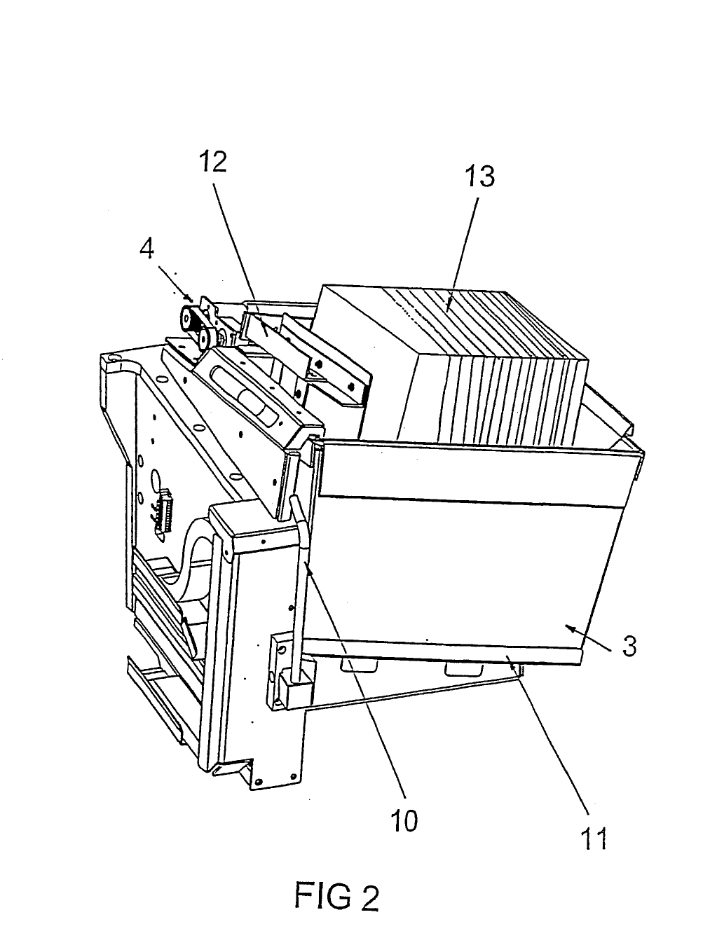

FIG. 1 depicts a stationary frame 1, slightly inclined to the rear, and comprising three successive stacking devices 20. Each stacking device comprises a pivoting unit 2. The pivoting units make use of known part-turn valve actuators to pivot between a substantially upright or top position and a horizontal or loading position. The two positions may be end positions separated by 90°. The pivoting unit 2 comprises a container receiver 11 for accommodating a container 3 (see FIG. 2). Container 3 comprises an open top and a plurality of walls defining a cavity and bottom. Containers for accommodating mail pieces therein are well known and often used in the art.

A path for the transportation of flat objects, which need to be stacked into the containers 3, is located above the pivoting units 2. The flat objects of this example embodiment comprise oversized letters. The transportation path comprises successively arranged and pivoting endless-loop band transporting modules 6. Rotating foam rolls 5 are included with the transporting modules 6 and serve to press the objects against the surface of the bands. If an object has to be stacked into a select container, then a select transporting module 6, located upstream from a select pivoting unit 2 associated with the select container, pivots downwards (by for example approximately 13°) and the object in question is guided into the container 3 via transporting module 6 and inserted into a stacking position. This may be effected by selection unit (not shown) as would be known to one skilled in the art. Because a further routing of the objects on top of the last pivoting unit 2 is no longer necessary, the last (most downstream) transporting module 6 remains in the downward pivoted position.

The containers 3 are inclined in the stacking position (depicted open on the left side) as well as in the container changing position (depicted opening on top), so the mail pieces being handled may be aligned by at least one edge.

In the depicted embodiment, the container change is performed manually. To facilitate an ergonomic position for container change while at the same time to be free from obstructions from the transporting modules 6 and elements, a horizontal extension unit 10 is included with the pivoting unit 2. The horizontal extension unit 10 comprises telescoping tracks which extend away from the frame and towards an operator. The pivoting unit installation facilitates manual extension which may be performed when the container is in a top position (open side up).

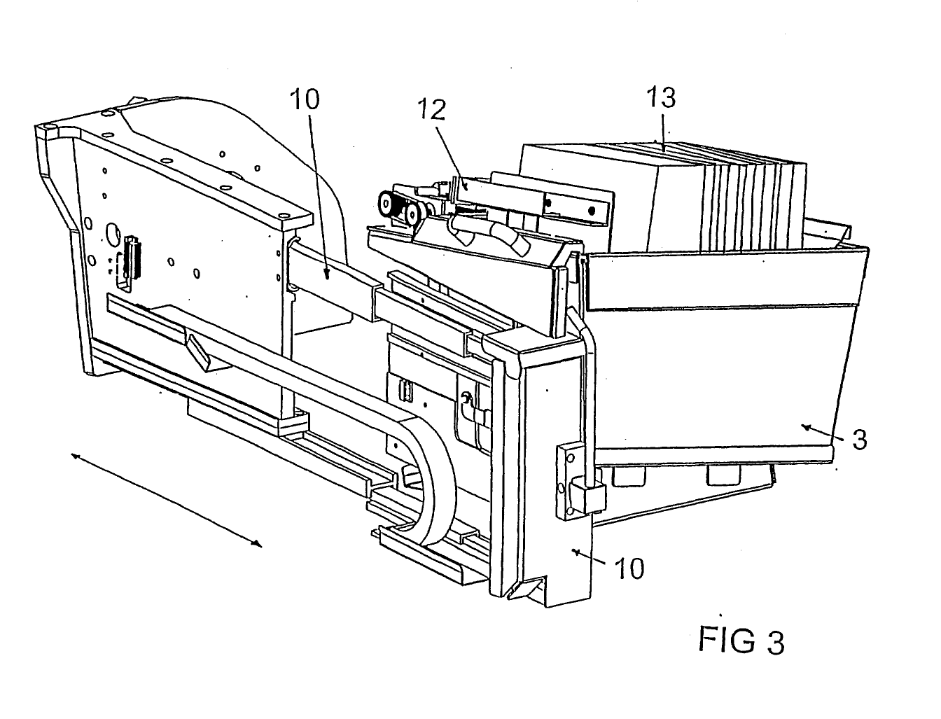

A container receiver 11 is located on a horizontal extension unit 10 and includes a stacking aid 12, which, if the horizontal extension unit 10 is extended, can be vertically lifted upwards from the container 3 (see FIG. 2 and FIG. 3). This may further be facilitated by a counterweight.

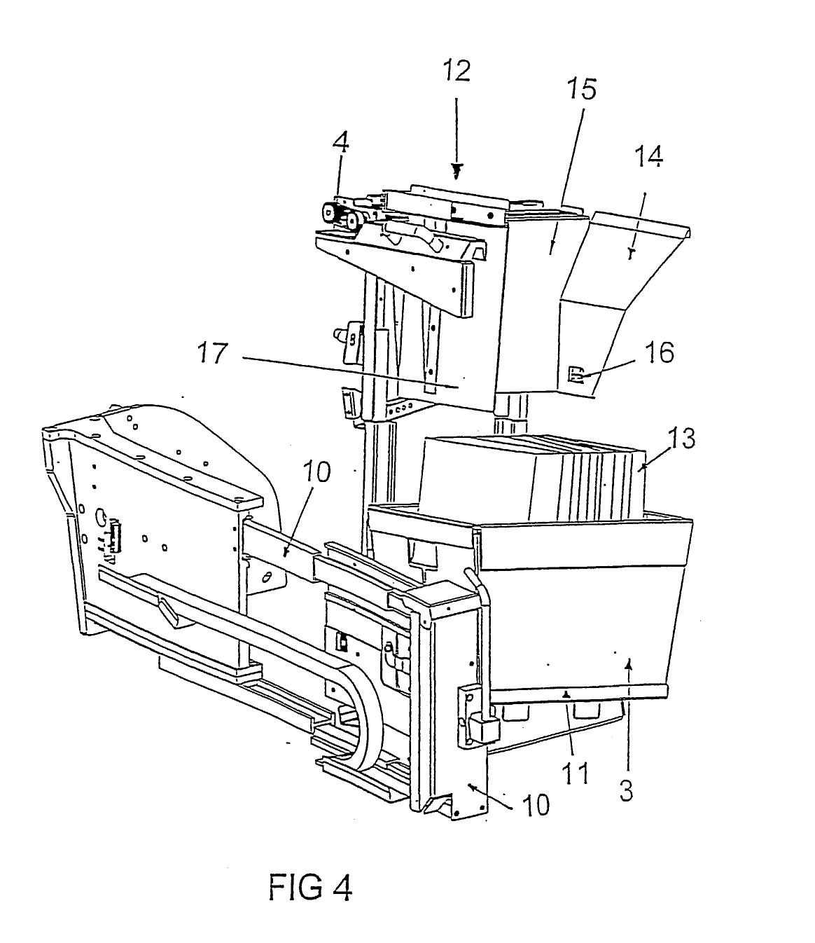

The stacking aid 12 is depicted in FIG. 4 in an elevated position. The stacking aid comprises a lateral wall 15 against which inserted mail pieces may be aligned. The lateral wall 15 levels out any inclines that may be present in a container wall. Accordingly, the stacking aid, and the present invention, is applicable to a wide variety of containers. A guiding mechanism 14 for the guiding the mail pieces into the container 3 is also provided. The guiding mechanism 14 may include a bin level sensor 16 which may be used to determine the height of the uppermost object in stack 13 with the objects in horizontal position by the distance (reflex sensor) or the volume (e.g. ultrasound). A lowerable, traveling stacking bottom 17 is also provided. Bottom 17 may be adjusted in at least two levels which are moveable in dependence of signals of the bin level sensor 16 so as to effect a relatively same ideal stacking conditions throughout the stack and container, i.e. the top object is always located at a predetermined distance. The stacking bottom 17 is moved with the aid of a moveable drive 4. Drive 4 comprises a motor which may be controlled by the bin level sensor 16 and a spindle drive driven by a short strap, at which spindle nut the stacking bottom 17 is then moved longitudinally.

Many containers have unfavorable designs for achieving a uniform and/or high stacking quality. For example, some containers used by the US Postal Service have outwardly inclined side walls. The material of the container also varies making some containers more stable than others when it comes to carrying heavy and/or disorganized loads. A stack 13 is therefore necessary in which all mail pieces are aligned towards their front edges and/or their longitudinal edges as well.

In operation, container 3 is tentered in the container receiver 11 on the pivoting unit 2. The pivoting unit 2 pivots into the stacking position and the mail pieces are inserted. The container bottom substantially perpendicular to the incoming mail piece serves as an impact wall for the incoming objects. The damping effect can be increased by an apt arrangement of damping material between the bottom of the container and the container receiver 11. An object, retarded accordingly, falls to rest directly on the subjacent arranged stack 13 and in particular stacking bottom 17 after being damped by the damping wall—in this case the bottom of the container. If the level sensor 16 registers a growth of the stack 13, it will be arranged, by the control system, that the stacking bottom 17 is lowered until the respective top object of the stack 13 has an optimal distance to the insertion level for the stacking of the next object.

Parameters influencing the stacking quality include: angle of inclination of the band diverter and hauling speed as well as orientation of the bottom of the container (impact wall) opposite to the pivoted band diverter.

When the lower final position of the stacking bottom 17 is reached, it is an indication of a fully loaded container and the loading of that container is halted.

For changing containers, the following procedure may be followed. The pivoting unit 2 is pivoted into the container changing position (the container 3 remains slightly inclined in the changing position, so that the stack doesn't turn over). The operator may now operate the horizontal extension unit 10 and pull out the fully charged container 3 from under the horizontally running route of the transportation module 6. It is now possible to manually lift the stacking aids 12 out from within the container 3. The objects stand now on their front edges having been supported by the shorter surface of the container and by the lateral wall 15 of the stacking aid 12. Following this, the fully loaded container 3 can be exchanged with an empty one. The stacking aid 12 is lowered and tenters the container 3 into the container receiver 11, the horizontal extension 10 is pushed in, and the pivoting unit 2 goes into the stacking position. The now empty container 3 can be reloaded.

To reduce the manual labor at the changing of the container or to effect automatic changing of the container, the following variation may be selected. When a container 3 is fully loaded, the pivoting unit pivots (back) into the top position. Here, the container 3 together with the container receiver 11 on which it stands, are lowered until the stacking aid 12 has completely moved out of the container 3. The lowering height may be a product of the tallest stacked object. The container 3 is thereby lowered proximate to a transportation path (not shown). The container receiver 11 is also lowered proximate to the transportation path, so that the container 3 can then be automatically or manually maneuvered onto the path with minimal resistance. Thereafter, a new empty container 3 may be pushed automatically or manually to the lowered container receiver 11 originating from, for example, the transportation path. Thereafter, the container receiver 11 rises again, thereby lifting the container 3 upwards to engage the waiting stacking aid 12. The container receiver 11 is picked up (latched), the lifting mechanism lowers, and the container 3 can then be pivoted into its stacking position.

The invention being thus described, it will be obvious that the same may be varied in many ways. Such variations may include use of the above described invention with any objects requiring stacking in containers, the objects being transportable via along transportation modules. The variations are not to be regarded as a departure from the spirit and scope of the invention, and all such modifications as would be obvious to one skilled in the art are intended to be included within the scope of the following claims.

We claim:

1. A stacking device for stacking an object in a stack within a container, said container having walls defining an open top, hollow cavity, and bottom, comprising:
a pivoting unit for pivoting said container between a top position, wherein said top faces substantially upward, and a stacking position, wherein said top faces substantially horizontally for further receiving said object into said cavity; and
a stacking aid for facilitating object stacking within said cavity, said stacking aid functionally associated with said pivoting unit so as to be lowered into said cavity, said stacking aid comprising a stacking bottom abutting at one end a lateral wall which further abuts a guiding mechanism, said stacking bottom accommodating a bottom of said stack, said lateral wall for damping an incoming object, and said guiding mechanism for guiding said stacking.

2. The device according to claim 1, wherein said object is relatively flat and includes a narrow side and a wide side.

3. The device according to claim 2, wherein said object is inserted into said container with its' narrow sides facing said lateral wall and said bottom.

4. The device according to claim 1, wherein said object is a mail piece.

5. The device according to claim 1, further comprising a container receiver functionally associated with said pivoting unit for accommodating said container.

6. The device according to claim 5, wherein said container is slightly inclined in said stacking position.

7. The device according to claim 1, wherein said stacking aid farther comprises a bin level sensor for recognizing stack height.

8. The device according to claim 7, wherein said bin level sensor is positioned on said guiding mechanism.

9. The device according to claim 7, wherein said stacking bottom engages said stack to maintain said stack at a select orientation.

10. The device according to claim 5, wherein said stacking device is mounted on a frame and said pivoting unit further comprises a horizontal extension unit to which said container receiver and said stacking aid are functionally associated, said horizontal extension unit facilitating extending movement away from said frame of said container receiver and stacking aid.

11. The device according to claim 10, wherein said horizontal extension unit is engageable only when said container is in said top position.

12. The device according to claim 10, wherein said horizontal extension unit further comprises telescopic tracks for effecting said extending movement.

13. The device according to claim 10, wherein said stacking aid is only moveable with respect to said container when said open top faces substantially upward.

14. The device according to claim 1, wherein said stacking aid further comprises means for automatically raising and lowering said stacking aid into and out from said container.

15. The device according to claim 1, wherein said stacking aid further comprises means for manually raising and lowering said stacking aid into and out from said container.

16. The device according to claim 5, further comprising container exchange means for automatically exchanging containers accommodated on said container receiver.

17. The device according to claim 16, further comprising container receiver lowering means for automatically lowering said container receiver with respect to said top position.

18. The device according to claim 5, further comprising container exchange means for manually exchanging containers accommodated on said container receiver.

19. The device according to claim 18, further comprising container receiver lowering means for manually lowering said container receiver with respect to said top position.

20. The device according to claim 10, further comprising container receiver lowering means for automatically lowering said container receiver with respect to said top position.

21. The device according to claim 20, wherein said automatic lowering may only be performed when said container receiver is extended from said frame.

22. The device according to claim 20, further comprising container exchange means for automatically exchanging containers accommodated on said container receiver.

23. The device according to claim 10, further comprising container receiver lowering means for manually lowering said container receiver with respect to said top position.

24. The device according to claim 23, wherein said manual lowering may only be performed when said container receiver is extended from said frame.

25. The device according to claim 23, further comprising container exchange means for manually exchanging containers accommodated on said container receiver.

26. A system for stacking an object in a container, said container having walls defining an open top, hollow cavity, and bottom, said system comprising:
a stacking device comprising a pivoting unit for pivoting said container between a top position, wherein said top faces substantially upward, and a stacking position, wherein said top faces substantially horizontally for further receiving said object into said cavity; and a stacking aid for facilitating object stacking within said cavity, said stacking aid functionally associated with said pivoting unit so as to be lowered into said cavity, said stacking aid comprising a stacking bottom abutting at one end a lateral wall which further abuts a guiding mechanism, said stacking bottom accommodating a bottom of said stack, said lateral wall for damping an incoming object, and said guiding mechanism for guiding said stacking; and
object transporting means for transporting said object to a stacking device, said object transporting means comprising a pivoting endless loop transporting module positioned upstream from said stacking device such that when said pivoting endless loop pivots into a loading position, said object is directed into said cavity.

27. The system according to claim 26, wherein said transporting means further comprises at least one roller for pressing said object against said transporting modules.

28. The system according to claim 27, further comprising:
a plurality of transportation modules and stacking devices, such that said transpiration modules are successively arranged upstream from said plurality of stacking devices; and
selection means for effecting select pivoting of select transportation modules such that a select object is directed to a select container.

29. The system according to claim 28, wherein said loading position is a downward position and said object is loaded into said cavity by said transportation module in a substantially horizontal position.

30. The system according to claim 26, wherein said stacking device further comprises a container receiver functionally associated with said pivoting unit for accommodating said container, said stacking device is mounted on a frame, and said pivoting unit further comprises a horizontal extension unit to which said container receiver and said stacking aid are functionally associated, said horizontal extension unit facilitating extending movement away from said frame for said container receiver and stacking aid.

31. The system according to claim 30, further comprising container transportation means for effecting conveyance of at least one container to and from said system.

32. A method for stacking an object in a container, said container having walls defining an open top, hollow cavity, and bottom, comprising the steps of:
pivoting said container into a stacking position with a pivoting unit of a stacking device, such that said open top faces substantially horizontally;
aiding said stacking with a stacking aid functionally associated with said pivoting unit so as to be lowered into said cavity, said stacking aid comprising a stacking bottom abutting at one end a lateral wall which further abuts a guiding mechanism, said stacking bottom accommodating a bottom of said stack, said lateral wall for damping an incoming object, and said guiding mechanism for guiding said stacking position; and
transporting said object to said stacking device via transporting means, said transporting means comprising at least one pivoting endless loop transporting module positioned upstream from said stacking device such that when said pivoting endless loop pivots into a loading position, said object is directed into said cavity
pivoting said transportation module into a loading position;
loading said object into said cavity such that a narrow end of said object engages said lateral wall and said bottom.

33. The method according to claim 32, wherein said stacking device further comprises a plurality of stacking devices and said endless transportation module comprises a plurality of modules positioned upstream from said stacking devices, and further comprising the step of engaging selection means for selectively pivoting a select transportation module to selectively stack an object into a select container.

34. The method according to claim 33, further comprising the step of automatically exchanging said container with an another container.

35. The method according to claim 33, further comprising the step of manually exchanging said container with an another container.

36. The method according to claim 34, wherein said step of automatically exchanging said container is triggered by a signal from a sensor functionally associated with said guiding mechanism.

37. The method according to claim 35, wherein said step of manually exchanging said container is triggered by a signal from a sensor functionally associated with said guiding mechanism.

38. The method according to claim 32, wherein said object is relatively flat.

39. The method according to claim 32, wherein said object is a mail piece.
